(19) United States
(12) Patent Application Publication
(10) Pub. No.: US 2025/0212912 A1
(43) Pub. Date: Jul. 3, 2025

(54) COLLAGEN PEPTIDE COMPOSITIONS FROM FISH SKINS AND SCALES AND METHODS FOR PRODUCING SAME

(71) Applicant: THAI UNION GROUP PUBLIC COMPANY LIMITED, Bangkok (TH)

(72) Inventors: Phatcharee Chaikitwisuttikul, Bangkok (TH); Pimphat Malaikritsanachalee, Bangkok (TH); Waraporn Kumkanokrat, Bangkok (TH); Siripop Singtokaew, Bangkok (TH); Supatsara Rujanant, Bangkok (TH); Treuktongjai Saenghiruna, Bangkok (TH); Czarina Kristine Rosales, Bangkok (TH)

(21) Appl. No.: 18/999,943

(22) Filed: Dec. 23, 2024

Related U.S. Application Data
(60) Provisional application No. 63/616,235, filed on Dec. 29, 2023.

(51) Int. Cl. A23J 3/34

(52) U.S. Cl. CPC A23J 3/342

(57) ABSTRACT

Collagen peptide compositions and methods for producing these collagen peptide compositions from fish skin or fish scale are provided. The collagen peptide compositions are characterized by high protein content, minimal impurities, enriched hydroxyproline, and specific peptide sequences, making them suitable for use as supplements or additives in food and beverages.

### PRIORITY CLAIM AND CROSS-REFERENCE

This application claims priority to U.S. Provisional Patent Application No. 63/616,235 filed Dec. 29, 2023, the disclosure of which is hereby incorporated by reference in its entirety.

### BACKGROUND

### Technical Field

The present disclosure relates to collagen peptide compositions obtained from fish and methods of producing the same. More specifically, the present disclosure relates to collagen peptide compositions obtained from fish skins and fish scales and methods of producing the same by enzymatic hydrolysis.

### Description of the Related Art

Collagen, renowned for its rich nutritional content and beneficial properties, has found extensive applications across various industries including food, pharmaceuticals, healthcare, and cosmetics. Collagen is a primary fibrous protein present in bone, cartilage, and skin tissues of sources like porcine, bovine, chicken, and fish. In the fish processing industry, by-products constitute more than 50% of the total weight and contain valuable active ingredients such as collagen peptides.

Collagen peptides, also called hydrolyzed gelatin or collagen hydrolysate, are soluble in water and provide numerous benefits for human health and beauty. The unique properties of collagen peptides make them suitable for utilization as ingredients and food supplements in the form of drinks, tablets, or powders, but also in liquid cosmetic applications, cremes, sprays, and mousses.

Collagen peptides are the building blocks of gelatin and can be produced by enzymatic hydrolysis of gelatin, using proteases. Hydrolyzed collagen peptides typically have a molecular weight between 0.3 and 8 kDa, depending on the extraction and processing methods used. They are water-soluble, highly digestible, easily absorbed, and can be distributed in the human body.

Efforts to capitalize on fish skins and scales as a major source of collagen have emerged due to its potential profitability and cost-effectiveness. However, extracting collagen peptides from fish skin and scales, especially from commonly caught marine species, such as tuna, pollock, and salmon, presents complexities in quality control. Variations in feeding habits across diverse marine environments contribute to challenges like undesirable odors and tastes, as well as impurities such as salts, minerals, and heavy metal contaminants stemming from the marine environment. Therefore, there is still a need for environmentally friendly processes for obtaining collagen peptides from fish skin and scales.

### BRIEF SUMMARY

In one aspect, provided herein is a collagen peptide composition comprising collagen proteins having an average molecular weight of less than 2000 Da and having a protein content of at least 90 wt % based on the total weight of the composition. Per 100 g of the collagen proteins comprises 7 to 10 g of hydroxyproline amino acids, 10 to 25 g of dipeptides, and 15 to 25 g of tripeptides.

In another aspect, provided herein is a method for producing a collagen peptide composition from fish skin. The method includes pretreating the fish skin with water at a temperature ranging from 30 to less than 60° C. for 10 to 30 minutes, extracting a crude collagen from the pretreated fish skin using a heated water of 60 to 90° C. for 1 to 5 hours; hydrolyzing the crude collagen by at least one protease enzyme; and isolating collagen peptides from the hydrolyzed collagen to provide the collagen peptide composition. The collagen peptide composition includes collagen proteins having an average molecular weight of less than 2000 Da and having a protein content of at least 90 wt % based on the total weight of the composition. Per 100 g of the collagen proteins includes 7 to 10 g of hydroxyproline amino acids, 10 to 25 g of dipeptides, and 15 to 25 g of tripeptides.

In still another aspect, provided herein is a method for producing a collagen peptide composition from fish scale. The method includes extracting a crude collagen from the fish scale using a heated water of 80 to 100° C. for 4 to 8 hours; hydrolyzing the crude collagen by at least one protease enzyme; and isolating collagen peptides from the hydrolyzed collagen to provide the collagen peptide composition. The collagen peptide composition includes collagen proteins having an average molecular weight of less than 2000 Da and having a protein content of at least 90 wt % based on the total weight of the composition. Per 100 g of the collagen proteins includes 7 to 10 g of hydroxyproline amino acids, 10 to 25 g of dipeptides, and 15 to 25 g of tripeptides.

### BRIEF DESCRIPTION OF THE SEVERAL VIEWS OF THE DRAWINGS

FIG. 1 is a flow chart of a method for producing a collagen peptide composition from fish skin, in accordance with some embodiments.

FIG. 2 is a flow chart of a method for producing a collagen peptide composition from fish scale, in accordance with some embodiments.

### DETAILED DESCRIPTION

Inland animals are rich in collagen; however, they are often contaminated with infectious agents, such as bovine spongiform encephalopathy (BSE) in cattle, enterovirus, and bird flu, which may cause safety concerns and require additional steps in production. Fish, in contrast, are considered one of the best alternative sources for collagen because they are more abundant than other aquatic animals, have a low risk of pathogen infection, and have excellent biocompatibility.

Fish collagen can be obtained from various byproducts of fish processing, such as fish bones, skins, and scales, which are often discarded as waste. These waste byproducts constitute a substantial portion of the raw materials, which typically accounts for approximately 50% to 70% of the entire weight of the fish processed daily by fish shops and processing factories worldwide. The fish collagen is highly sought after by consumers due to its nutritional benefits as well as cultural, social, and religious significance. However, impurities such as fat, oil, and ash present in the crude collagen need to be removed. Chemicals are commonly used to remove grease, ash, and other impurities from crude collagen, necessitating an additional neutralization process that adds complexity to collagen production. Moreover, the disposal of the chemical waste generated from the crude collagen treatment is expensive, further increasing the production costs.

To overcome these problems, the present disclosure provides non-chemical treatment processes for producing collagen peptides from fish skins and scales. This approach enables an environmentally friendly and hazard-free working procedure, while preserving the quality and yield of the collagen peptides and minimizing production costs. Furthermore, the collagen peptide process design of the present disclosure extends beyond the skins and scales of marine fish, such as tuna, pollock, cod, and salmon, to include the skins and scales of freshwater fish, such as tilapia, carp, and pangasius.

The processes for producing fish collagen peptide compositions according to the present disclosure involve a meticulous series of technical procedures, including pretreatment, extraction, enzymatic hydrolysis, purification, concentration, sterilization, and drying. Extracting the collagen peptides from fish skins and scales requires intricate methodologies, particularly in controlling the quality of skins and scales, in order to achieve the desirable characteristics. Various technologies, such as thermal and enzymatic hydrolysis treatments, are employed to extract collagen from the fish skins and scales. The present disclosure combines a pretreatment process and a collagen extraction treatment process, which allows for precise enzyme cutting under suitable hydrolysis conditions. This tailored combination approach enables the production of high-quality collagen peptide products with specific characteristics and sequences. The process parameters and conditions are meticulously established to achieve efficient industrial production of collagen peptides from the skins and scales of both freshwater fish and marine fish. The present disclosure also includes purification steps to remove impurities such as minerals, salts, contaminants, and odors from the crude collagen solution, resulting in tasteless, colorless, and odorless collagen peptide products. Drying techniques further enhance the products' appealing appearance and improve their dissolution. These high-quality collagen peptides have versatile applications across a wide array of uses, including supplements, food, and beverages.

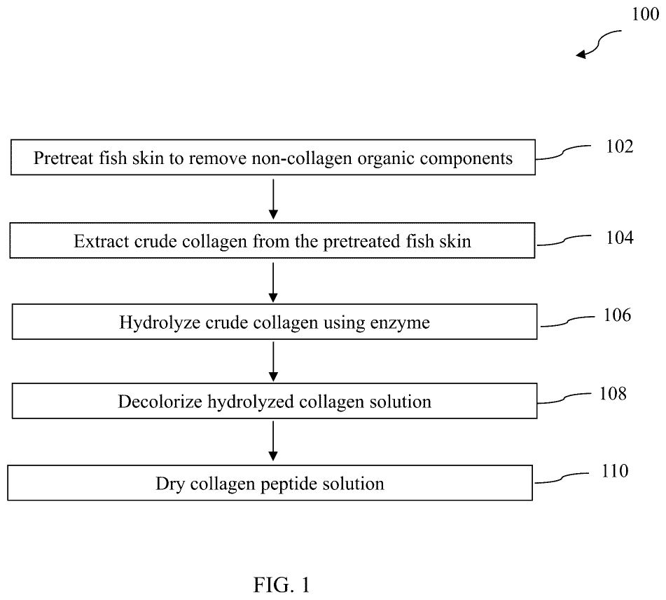

In some embodiments, the collagen peptides are produced from fish skins. FIG. 1 is a flow chart of a method 100 for producing a collagen peptide composition from fish skin, in accordance with some embodiments of the present disclosure. It is understood that additional steps can be provided before, during, and after method 100, and some of the steps described below can be replaced or eliminated, for additional embodiments of the method.

Referring to FIG. 1, the method 100 includes operation 102, where the raw fish skin undergoes pretreatment to remove non-collagen organic components, such as fat and oil. At operation 102, the raw fish skin is initially cleaned with water and grinded into small pieces or pastes. Subsequently, the non-collagen organic components, such as fat and oil, are removed by a low temperature separation process, conducted at 30° C. to less than 60° C. for 10 to 30 minutes with water, resulting in a skin sludge. During the low temperature separation process, water is first added to the grinded fish skin, followed by heating the mixture using a tubular heat exchanger. The heated grinded fish skin is then passed through a 3-phase decanter to separate the solid and liquid phases. The solid phase provides the skin sludge.

The fish skin can be obtained from any fish species, including marine fish such as tuna, pollock, cod, and salmon, or freshwater fish such as tilapia, carp, and pangasius. In some embodiments, prior to using the fish skin, the fish skin may be washed multiple times with water to remove any dirt or contaminants adhering to the fish skin.

At operation 104, crude collagen is extracted from the skin sludge. In some embodiments, the extraction process involves adding water to the skin sludge at a weight-to-volume ratio (w/v) ranging from 1:1 to 10:1. The resulting mixture is then heated to a temperature ranging from 60° C. to 90° C. for 1 to 5 hours to facilitate the extraction of crude collagen from the skin sludge. In certain embodiments, the crude collagen is extracted from the skin sludge by adding water to the skin sludge at a ratio of 2:1 to 3:1 (w/v). The mixture is heated to a temperature ranging from 75° C. to 85° C., and maintained at that temperature for 2 to 3 hours.

No chemicals, such as acid or base, are used in the fish skin pretreatment or collagen extraction operations. As a result, no additional neutralization step is needed for chemical waste treatment in the present disclosure. This makes the process of the present disclosure environmentally friendly and reduces manufacturing costs.

At operation 106, the crude collagen is hydrolyzed by at least one enzyme to break down the collagen molecules into peptides. In some embodiments, the enzyme treatment is carried out by, for example, reacting 0.5 to 1.5 wt % of enzyme relative to the crude collagen solution at a temperature ranging from 50° C. to 80° C. for 1 to 5 hours. The pH of the crude collagen solution is adjusted to between 5.5 to 7 so that the collagen is cleaved into proteins having an average molecular weight of less than 2,000 Da. It is contemplated that the temperature range and time duration for enzyme treatment are just provided as examples and may be adjusted to achieve sufficient exertion of enzyme functions while avoiding excessive progression of collagen digestion, thereby achieving a collagen peptide composition having the target average molecular weight, high protein content, and high dipeptide content. In some embodiments, the enzyme is a protease or a protease complex comprising a protease and one or more additional enzymes. The additional enzyme in the protease complex may, in some embodiments, be a different protease or a non-protease enzyme. In some embodiments, the protease enzyme may be selected from the group of proteases derived from plants, animals, or microorganisms. The protease may be an alkaline protease, neutral protease, serine protease, cysteine protease, metalloprotease, or aminopeptidase. Enzymes that may be included in the protease complex include, but are not limited to, alkaline protease, neutral protease, serine protease, cysteine protease and metalloprotease, aminopeptidase, collagenase, papain, bromelain, actinidin, ficin, cathepsin, pepsin, chymosin, and trypsin. In certain embodiments, after adjusting the pH of the crude collagen, the crude collagen is hydrolyzed at a temperature ranging from 55 to 65° C. for 1 to 2 hours using at least one alkali protease. After the enzyme reaction is completed, the solution is heated to 90° C. or higher and maintained at that temperature for a duration of 30 minutes to inactivate the enzyme. Enzyme treatment at a temperature higher than 100° C. is undesirable since such treatment may destroy the flavor. Subsequently, the undissolved solid in the collagen solution is removed by, for example, filtration or centrifugation. In some embodiments, the undissolved solid is removed by separation. The remaining liquid provides a hydrolyzed collagen solution.

At operation 108, the hydrolyzed collagen solution is decolorized. In some embodiments, the hydrolyzed collagen solution is first heated to a temperature ranging from 65° C. to 95° C. Activated carbon is then added into the heated solution at a concentration ranging from 1 to 5% (w/v). After reacting for 30 to 90 minutes, the activated carbon residue is removed by filtration, thereby providing a collagen peptide solution. In certain embodiments, decolorization is performed by heating the solution to 75° C. to 85° C., adding activated carbon at a concentration of 2% to 3% (w/v), and allowing the reaction to proceed for 45 to 60 minutes before filtering out the activated carbon residue.

At operation 110, the collagen peptide solution is dried, for example, by spray drying or using a drum dryer to provide a collagen peptide composition. In some embodiments, the collagen peptide composition is in powdered form. In some embodiments, the collagen peptide composition comprises powders having a particle size ranging from 15 μm to 450 μm.

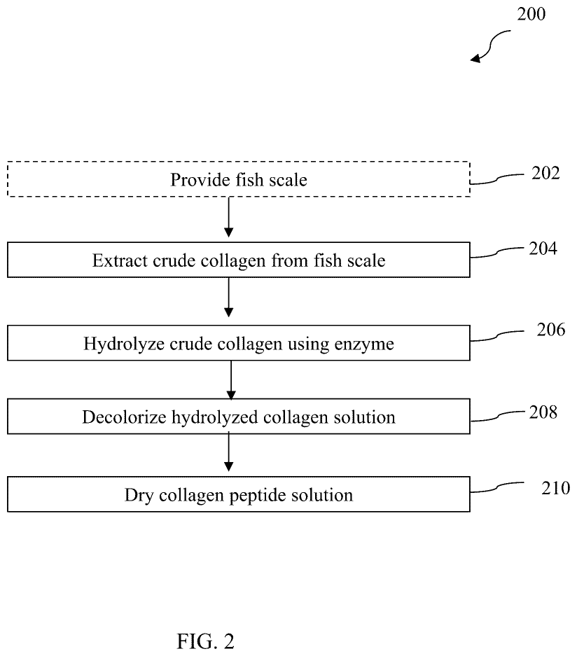

In some embodiments, the collagen peptides are produced from fish scales. FIG. 2 is a flow chart of a method 200 for producing a collagen peptide composition from fish scale, in accordance with some embodiments of the present disclosure. It is understood that additional steps can be provided before, during, and after method 200, and some of the steps described below can be replaced or eliminated, for additional embodiments of the method.

Referring to FIG. 2, the method 200 includes operation 202, where the fish scale is provided as the raw material. The fish scale may be obtained from commercial sources and used as-is or subjected to additional treatment. In some embodiments, the fish scale is washed multiple times with water to remove dirt or contaminants adhering to the fish scale. Following washing, the fish scale undergoes a demineralization process to remove inorganic components, such as phosphorus and calcium. In some embodiments, demineralization is achieved by soaking the fish scale in an acid solution, such as an HCl solution for 60 to 120 minutes. The demineralized fish scale is then washed with water to remove residual acid. In some embodiments, the fish scale is first soaked in a base solution, such as a sodium hydroxide or sodium bicarbonate solution for 60 to 120 minutes, prior to using an acid solution. The fish scale is then washed with water to remove the residual base. The demineralized scale is then dried, and in some embodiments, grinded into small pieces to enhance the efficiency during the collagen extraction process subsequently performed.

The fish scale can be obtained from any fish species, including marine fish such as tuna, pollock, cod, and salmon, or freshwater fish such as tilapia, carp, and pangasius. In some embodiments, the fish scale is obtained from tilapia. In some embodiments, the fish scale is obtained from carp.

At operation 204, crude collagen is extracted from the fish scale. In some embodiments, the extraction process involves adding water to the fish scale at a ratio of 1:1 to 10:1 (w/v). The resulting mixture is then heated to a temperature ranging from 80° C. to 100° C. for 4 to 8 hours to facilitate the extraction of crude collagen from the fish scale. In certain embodiments, the crude collagen is extracted from the fish scale by adding water to the fish scale at a ratio ranging from 8:1 to 10:1 (w/v). The mixture is heated to a temperature ranging from 85° C. to 95° C., and maintained at that temperature for 5 to 6 hours.

No chemicals, such as acid or base, are used in the collagen extraction operation. As a result, no additional neutralization step is needed for chemical waste treatment in the present disclosure. This makes the process of the present disclosure environmentally friendly and reduces manufacturing costs.

At operation 206, the crude collagen is hydrolyzed by at least one enzyme to break down the collagen molecules into peptides. In some embodiments, the enzyme treatment is carried out by, for example, reacting 0.5 to 1.5 wt % of enzyme relative to the crude collagen solution at a temperature ranging from 50° C. to 90° C. for 1 to 10 hours. The pH of the crude collagen solution is adjusted to between 5.5 to 7 so that the collagen is cleaved into proteins having an average molecular weight of less than 2,000 Da. It is contemplated that the temperature range and time duration for enzyme treatment are just provided as examples and may be adjusted to achieve sufficient exertion of enzyme functions while avoiding excessive progression of collagen digestion, thereby achieving a collagen peptide composition having the target average molecular weight, high protein content, and high dipeptide content. In some embodiments, the enzyme is a protease or a protease complex comprising a protease and one or more additional enzymes. The additional enzyme in the protease complex may, in some embodiments, be a different protease or a non-protease enzyme. In some embodiments, the protease enzyme may be selected from the group of proteases derived from plants, animals, or microorganisms. The protease may be an alkaline protease, neutral protease, serine protease, cysteine protease, metalloprotease, or aminopeptidase. Enzymes that may be included in the protease complex include, but are not limited to, alkaline protease, neutral protease, serine protease, cysteine protease, metalloprotease, aminopeptidase, collagenase, papain, bromelain, actinidin, ficin, cathepsin, pepsin, chymosin, and trypsin. In certain embodiments, after adjusting the pH of the crude collagen, the crude collagen is hydrolyzed at a temperature ranging from 55 to 75° C. for 2 to 8 hours using at least one alkali protease. After the enzyme reaction is completed, the solution is heated to 90° C. or higher and maintained at that temperature for a duration of 30 minutes to inactivate the enzyme. Enzyme treatment at a temperature higher than 100° C. is undesirable since such treatment may destroy the flavor. Subsequently, the undissolved solid in the collagen solution is removed by, for example, filtration or centrifugation. In some embodiments, the undissolved solid is removed by separation. The remaining liquid provides a hydrolyzed collagen solution.

At operation 208, the hydrolyzed collagen solution is decolorized to provide a collagen peptide solution. The process at operation 208 is identical to that described above in operation 108; therefore, the details are not repeated here for brevity.

At operation 210, the collagen peptide solution is dried to provide a collagen peptide composition. The process at operation 210 is identical to that described above in operation 110; therefore, the details are not repeated here for brevity.

The collagen peptide composition produced according to method 100 or method 200 is distinguished by its high protein content, minimal impurities, enriched hydroxyproline, and specific peptide sequences. In some embodiments, the collagen peptide composition comprises 90 wt % or greater, based on the total weight of the composition, of collagen proteins. In some embodiments, the collagen peptide composition comprises 90 to 98 wt %, based on the total weight of the composition, of collagen proteins. The collagen proteins have a low average molecular weight, which allows for easy digestion and absorption. In some embodiments, the collagen proteins have an average molecular weight of less than 2000 Da. In some moments, the collagen proteins have an average molecular weight ranging from 900 to 1500 Da.

Moreover, the collagen peptide composition of the present disclosure is characterized in that per 100 g, the collagen proteins are comprised of 7 to 10 g of hydroxyproline amino acids, 10 to 25 g of dipeptides, and 15 to 25 g of tripeptides. The sequence analysis performed using liquid chromatography-mass spectroscopy/mass spectroscopy (LC-MS/MS) indicates that the dipeptides include a proline-hydroxyproline (Pro-Hyp) sequence, a glycine-hydroxyproline (Gly-Hyp) sequence, a proline-alanine (Pro-la) sequence, a hydroxyproline-glycine (Hyp-Gly), an alanine-hydroxyproline (Ala-Hyp) sequence, or a combination thereof, and the tripeptides include a glycine-proline-alanine (Gly-Pro-Ala) sequence, a glycine-alanine-hydroxyproline (Gly-Ala-Hyp) sequence, a glycine-proline-serine (Gly-Pro-Ser) sequence, or a combination thereof.

In some embodiments, the collagen peptide composition may optionally include fat, ash, carbohydrate, salt, and moisture. In some embodiments, the collagen peptide composition includes, based on the total weight of the composition, 0 to 3 wt % of fat, 0 to 2 wt % of ash, 0 to 1 wt % of carbohydrate, 0 to 1 wt % of salt, and 0 to 10 wt % of moisture.

The collagen peptide composition may be added to a food and beverage for daily intake. The form of a food or beverage to be mixed with the collagen peptide composition may be either a solid form or a liquid form. Specific examples of the types of foods or beverages include, but are not limited to, beverages such as soft drinks, carbonated drinks, nutritional beverages, fruit beverages, and milk beverages (including a concentrated stock solution of such a beverage and a dry powder for preparation of such a beverage); frozen desserts such as ice cream, ice sherbet, and shaved ice; noodles such as buckwheat noodles, wheat noodles, bean-starch Vermicelli, gyoza wraps (pot stickers), Chinese noodles, and instant noodles; confectioneries such as candy, chewing gum, candy, gummi candy, gum, caramel, chocolate, tablet sweets, snacks, baked goods (e.g., biscuit), jelly, jam, and cream; fish-livestock processed foods such as minced and steamed fish, hamburger, ham, and sausage; dairy products such as processed milk, fermented milk, yogurt, butter, and cheese; fats and oils and fat and oil processed foods such as salad oil, tempura oil, margarine, mayonnaise, shortening, whipped cream, and dressing; seasonings such as sauce and baste; and soup, stew, curry, bread, jam, salad, daily dishes, and Japanese pickles.

### EXAMPLES

### Example 1

### General Procedure for Producing Collagen Peptide Compositions

Raw fish skin, from tilapia, carp, pangasius, pollock, cod, salmon, or tuna, was grinded into small pieces or paste. Fat in the raw fish skin was removed by a low temperature separation process with water at 30 to less than 60° C. for 10-30 min to obtain a skin sludge. Water was then added to the skin sludge at a ratio of from 1:1 to 10:1 (w/v) and the resulting mixture was heated to 60-90° C., for 1-5 hours to extract crude collagen. The solution containing the crude collagen was removed from the skin sludge using two-phase separation. The pH of the crude collagen was adjusted to 5.5-7.0, after which the crude collagen was hydrolyzed for 1-5 hours at 50-80° C. with at least one alkali protease in an amount of 0.5-1.5 wt % relative to the crude collagen. The enzyme hydrolysis process resulted in the collagen being broken down into proteins having an average molecular weight of less than 2,000 Da. The enzyme was inactivated by heating the mixture at 90° C. for 30 min. Undissolved solid was removed by a Separator, thereby providing a collagen peptide composition. The collagen peptide composition was decolorized by first heating the solution to 65-95° C., then adding activated carbon at a concentration of 1-5% (w/v), and allowing the decolorization to complete for 30-90 min. The activated carbon residue was removed using a filter press. The compositions of the collagen peptide products were evaluated. The results are summarized in Tables 1-4.

TABLE 1
Compositions and Characteristics of
Collagen Peptides from Tuna Skins

| | Skipjack | Skipjack | Yellowfin | Yellowfin |
|---|---|---|---|---|
| Composition | skin I | skin II | skin I | skin II |
| Protein (wt %) | 97.40 | 97.10 | 95.60 | 95.41 |
| Hydroxyproline | 9.86 | 9.90 | 10.00 | 9.62 |
| (g/100 g total | | | | |
| protein) | | | | |
| Fat (wt %) | 0.18 | 0.34 | <0.01 | <0.01 |
| Ash (wt %) | 0.12 | 0.05 | 0.15 | 0.07 |
| Carbohydrate | 0.14 | 0.00 | 0.00 | 0.00 |
| (wt %) | | | | |
| Moisture (wt %) | 2.16 | 3.28 | 4.20 | 4.20 |
| Salt (wt %) | 0.13 | 0.16 | Not detected | <0.01 |
| Average | 998 | 1446 | 1445 | 1920 |
| molecular weight | | | | |
| (Da) | | | | |
| Dipeptide | 18.35 | 14.57 | 18.91 | 17.95 |
| (g/100 g total | | | | |
| protein) | | | | |
| Tripeptide | 21.50 | 17.60 | 23.25 | 16.88 |
| (g/100 g total | | | | |
| protein) | | | | |

TABLE 2
Compositions and Characteristics of Collagen
Peptides from Fresh Water Fish Skins

| Composition | Pangasius skin | Tilapia skin |
|---|---|---|
| Protein (wt %) | 95.50 | 95.02 |
| Hydroxyproline | 9.32 | 9.99 |
| (g/100 g total protein) | | |
| Fat (wt %) | 1.77 | <0.01 |
| Ash (wt %) | 0.63 | 0.34 |
| Carbohydrate (wt %) | 0.00 | 0.84 |
| Moisture (wt %) | 3.44 | 3.80 |
| Salt (wt %) | 0.09 | 0.19 |
| Average molecular weight | 1188 | 1736 |
| (Da) | | |
| Dipeptide | 17.78 | 17.33 |
| (g/100 g total protein) | | |
| Tripeptide | 21.71 | 16.76 |
| (g/100 g total protein) | | |
| Dipeptide (ppm) | | |
| Pro-Hyp | 3833 | 122 |
| Gly-Pro | 997 | 316 |
| Pro-Ala | 0 | 17 |
| Tripeptide (ppm) | | |
| Gly-Pro-Ala | 0 | 538 |
| Gly-Pro-Leu | 493 | 274 |

TABLE 3
Compositions and Characteristics of Collagen
Peptides from Marine Fish Skins

| Composition | Pollock skin | Cod skin | Salmon skin |
|---|---|---|---|
| Protein (wt %) | 93.29 | 93.20 | 98.50 |
| Hydroxyproline | 7.67 | 8.00 | 7.84 |
| (g/100 g total protein) | | | |
| Fat (wt %) | 2.78 | 1.12 | 0.17 |
| Ash (wt %) | 0.93 | 1.69 | 0.05 |
| Carbohydrate (wt %) | 0.00 | 0.98 | 0.00 |
| Moisture (wt %) | 3.00 | 3.00 | 1.30 |
| Salt (wt %) | 0.66 | 1.25 | 0.68 |
| Average molecular weight | 1528 | 1244 | 1442 |
| (Da) | | | |
| Dipeptide | 16.80 | 19.70 | Not available |
| (g/100 g total protein) | | | |
| Tripeptide | 20.20 | 20.54 | Not available |
| (g/100 g total protein) | | | |

TABLE 4
Compositions and Characteristics of Collagen
Peptides from Fresh Water Fish Scales

| Composition | Tilapia scale |
|---|---|
| Protein (wt %) | 94.00 |
| Hydroxyproline | 11.00 |
| (g/100 g total protein) | |
| Fat (wt %) | 0.10 |
| Ash (wt %) | 1.35 |
| Carbohydrate (wt %) | 0.52 |
| Moisture (wt %) | 4.03 |
| Salt (wt %) | 0.50 |
| Average molecular weight | 1028 |
| (Da) | |
| Dipeptide | 24.85 |
| (g/100 g total protein) | |
| Tripeptide | 25.58 |
| (g/100 g total protein) | |

The resulting collagen peptide products were further sequenced by liquid chromatography-mass spectroscopy/mass spectroscopy (LC-MS/MS). Examples of the contents of dipeptide and tripeptide sequences are provided in Table 5.

TABLE 5
Contents of Dipeptide and Tripeptide
Sequences in Tuna Collagen Peptides

| | | Skipjack | Skipjack | Yellowfin | Yellowfin |
|---|---|---|---|---|---|
| Collagen Peptide | | skin I | skin II | skin I | skin II |
| Dipeptide | Pro-Hyp | 1370 | 2899 | 473 | 1340 |
| | (ppm) | | | | |
| | Gly-Pro | 8427 | 6393 | 2427 | 1631 |
| | (ppm) | | | | |
| | Pro-Ala | 4451 | 3884 | 4351 | 2631 |
| | (ppm) | | | | |
| | Hyp-Gly | 1046 | 1723 | 614 | 750 |
| | (ppm) | | | | |
| | Ala-Hyp | 493 | 462 | 283 | 434 |
| | (ppm) | | | | |
| Tripeptide | Gly-Pro-Ala | 3341 | 2907 | 3307 | 2070 |
| | (ppm) | | | | |
| | Gly-Pro-Ser | 1154 | 2274 | 479 | 188 |
| | (ppm) | | | | |
| | Gly-Ala-Hyp | 163 | 203 | 63 | 82 |
| | (ppm) | | | | |

### Example 2

Procedure for Producing Collagen Peptide Compositions from Fish Skins

Raw fish skin, from tilapia, carp, pangasius, pollock, cod, salmon, or tuna, preferably from tilapia or tuna, was grinded into small pieces or paste. Fat in the raw fish skin was removed by a low temperature separation process with water at 30 to less than 60° C. for 10-30 min to obtain a skin sludge. Water was then added to the skin sludge at a ratio of from 2:1 to 3:1 (w/v) and the resulting mixture was heated to 75-85° C., for 2-3 hours to extract crude collagen. The solution containing the crude collagen was removed from the skin sludge using two-phase separation. The pH of the crude collagen was adjusted to 5.5-7.0, after which the crude collagen was hydrolyzed for 1-5 hours at 50-80° C. with at least one alkali protease in an amount of 0.5-1.5 wt % relative to the crude collagen. The collagen was broken down into proteins having an average molecular weight of less than 2,000 Da. The enzyme was inactivated by heating the mixture at 90° C. for 30 min. Undissolved solid was removed by a Separator, thereby providing a collagen peptide composition. The collagen peptide composition was decolorized by first heating the solution to 65-95° C., then adding activated carbon at a concentration of 1-5% (w/v), and allowing the decolorization to complete for 30-90 min. The activated carbon residue was removed using a filter press.

### Example 3

Procedure for Producing Collagen Peptide Compositions from Fish Skins

Raw fish skin, from tilapia, carp, pangasius, pollock, cod, salmon, or tuna, preferably from tilapia or tuna, was grinded into small pieces or paste. Fat in the raw fish skin was removed by a low temperature separation process with water at 30 to less than 60° C. for 10-30 min to obtain a skin sludge. Water was then added to the skin sludge at a ratio of from 1:1 to 10:1 (w/v) and the resulting mixture was heated to 60-90° C. for 1-5 hours to extract crude collagen. The solution containing the crude collagen was removed from the skin sludge using two-phase separation. The pH of the crude collagen was adjusted to 5.5-7.0, after which the crude collagen was hydrolyzed for 1-2 hours at 55-65° C. with at least one alkali protease in an amount of 0.5-1.5 wt % relative to the crude collagen. The collagen was broken down into proteins having an average molecular weight of less than 2,000 Da. The enzyme was inactivated by heating the mixture at 90° C. for 30 min. Undissolved solid was removed by a Separator, thereby providing a collagen peptide composition. The collagen peptide composition was decolorized by first heating the solution to 65-95° C., then adding activated carbon at a concentration of 1-5% (w/v), and allowing the decolorization to complete for 30-90 min. The activated carbon residue was removed using a filter press.

### Example 4

Procedure for Producing Collagen Peptide Compositions from Fish Skins

Raw fish skin, from tilapia, carp, pangasius, pollock, cod, salmon, or tuna, preferably from tilapia and tuna, was grinded into small pieces or paste. Fat in the raw fish skin was removed by a low temperature separation process with water at 30 to less than 60° C. for 10-30 min to obtain a skin sludge. Water was then added to the skin sludge at a ratio of 1:1-10:1 (w/v) and the resulting mixture was heated to 60-90° C., for 1-5 hours to extract the crude collagen. The solution containing the crude collagen was removed from the skin sludge using two-phase separation. The pH of the crude collagen was adjusted to 5.5-7.0, after which the crude collagen was hydrolyzed for 1-5 hours at 50-80° C. with at least one alkali protease in an amount of 0.5-1.5 wt % relative to the crude collagen. The collagen was broken down into proteins having an average molecular weight of less than 2,000 Da. The enzyme was inactivated by heating the mixture at 90° C. for 30 min. Undissolved solid was removed by a Separator, thereby providing a collagen peptide composition. The collagen peptide composition was decolorized by first heating the solution to 75-85° C., then adding activated carbon at a concentration of 2-3% (w/v), and allowing the decolorization to complete for 45-60 min. The activated carbon residue was removed using a filter press.

### Example 5

Procedure for Producing Collagen Peptide Compositions from Fish Scales

Dried, demineralized fish scale, from tilapia, carp, pangasius, pollock, cod, salmon or tuna, preferably from tilapia or carp, was grinded into small pieces. Water was then added to the fish scale at a ratio of from 1:1 to 10:1 (w/v) and the resulting mixture was heated to 80-100° C., for 4-8 hours to extract the crude collagen. The solution containing the crude collagen was removed from the fish scale using two-phase separation. The pH of the crude collagen was adjusted to 5.5-7.0, after which the crude collagen was hydrolyzed for 1-10 hours at 50-90° C. with at least one alkali protease in an amount of 0.5-1.5 wt % relative to the crude collagen. The collagen was broken down into proteins having an average molecular weight of less than 2,000 Da. The enzyme was inactivated by heating the mixture at 90° C. for 30 min. Undissolved solid was removed by a Separator, thereby providing a collagen peptide composition. The collagen peptide composition was decolorized by first heating the solution to 65-95° C., then adding activated carbon at a concentration of 1-5% (w/v), and allowing the decolorization to complete for 30-90 min. The activated carbon residue was removed using a filter press.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A collagen peptide composition comprising collagen proteins having an average molecular weight of less than 2000 Da and having a protein content of at least 90 wt % based on the total weight of the composition,
wherein per 100 g of the collagen proteins comprises 7 to 10 g of hydroxyproline amino acids, 10 to 25 g of dipeptides and 15 to 25 g of tripeptides.

2. The composition of claim 1, further comprising, based on the total weight of the composition, 0 to 3 wt % of fat, 0 to 2 wt % of ash, 0 to 1 wt % of carbohydrate, 0 to 1 wt % of salt and 0 to 10 wt % of moisture.

3. The composition of claim 1, wherein the dipeptides comprise a mixture of a Pro-Hyp sequence, a Gly-Pro sequence, a Pro-Ala sequence, a Hyp-Gly sequence and an Ala-Hyp sequence.

4. The composition of claim 1, wherein the tripeptides comprise a mixture of a Gly-Pro-Ala sequence, a Gly-Ala-Hyp sequence and a Gly-Pro-Ser sequence.

5. A food or beverage containing the composition of claim 1.

6. A method for producing a collagen peptide composition from fish skin, comprising:
pretreating the fish skin with water at a temperature ranging from 30 to less than 60° C. for 10 to 30 minutes;
extracting a crude collagen from the pretreated fish skin using a heated water of 60 to 90° C. for 1 to 5 hours;
hydrolyzing the crude collagen by at least one protease enzyme; and
isolating collagen peptides from the hydrolyzed collagen to provide the collagen peptide composition, the collagen peptide composition comprising collagen proteins having an average molecular weight of less than 2000 Da and having a protein content of at least 90 wt % based on the total weight of the composition, wherein per 100 g of the collagen proteins comprises 7 to 10 g of hydroxyproline amino acids, 10 to 25 g of dipeptides and 15 to 25 g of tripeptides.

7. The method of claim 6, further comprising grinding the fish skin into a paste, wherein the pretreatment of the fish skin is carried out on the paste to remove fat and oil contents, thereby providing a skin sludge with reduced fat and oil contents.

8. The method of claim 6, wherein extracting the crude collagen from the pretreated fish skin comprises:
adding water to the pretreated fish skin at a ratio of from 1:1 to 10:1 (w/v) to provide a mixture;
heating the mixture to a temperature ranging from 60 to 90° C.; and
allowing extraction of the crude collagen from the pretreated fish skin from 1 to 5 hours to obtain a crude collagen solution.

9. The method of claim 8, wherein hydrolyzing the crude collagen by the at least one enzyme comprises:
adding a protease enzyme or a protease enzyme complex to the crude collagen solution in an amount ranging from 0.5 to 1.5 wt % relative to the crude collagen solution;
adjusting a pH value of the crude collagen solution to 5.5 to 7; and
incubating the crude collagen solution at 50° C. to 80° C. for 1 to 5 hours; and
inactivating the protease enzyme or the protease enzyme complex.

10. The method of claim 6, further comprising decolorizing the collagen peptide composition using activated carbon.

11. The method of claim 6, wherein the fish skin is obtained from a marine fish.

12. The method of claim 11, wherein the marine fish comprises pollock, cod, salmon or tuna.

13. The method of claim 6, wherein the fish skin is obtained from a freshwater fish.

14. The method of claim 13, wherein the freshwater fish comprises tilapia, carp or pangasius.

15. A method for producing a collagen peptide composition from fish scale, comprising:
extracting a crude collagen from the fish scale using a heated water of 80 to 100° C. for 4 to 8 hours;
hydrolyzing the crude collagen by at least one protease enzyme; and
isolating collagen peptides from the hydrolyzed collagen to provide the collagen peptide composition, the collagen peptide composition comprising collagen proteins having an average molecular weight of less than 2000 Da and having a protein content of at least 90 wt % based on the total weight of the composition, wherein per 100 g of the collagen proteins comprises 7 to 10 g of hydroxyproline amino acids, 10 to 25 g of dipeptides and 15 to 25 g of tripeptides.

16. The method of claim 15, wherein extracting the crude collagen from the fish scale comprises:
adding water to the fish scale at a ratio of from 1:1 to 10:1 (w/v) to provide a mixture;
heating the mixture to a temperature ranging from 80 to 100° C.; and
allowing extraction of the crude collagen from the fish scale from 4 to 8 hours to obtain a crude collagen solution.

17. The method of claim 16, wherein hydrolyzing the crude collagen by at least one protease enzyme comprises:
adding a protease enzyme or a protease enzyme complex to the crude collagen solution in an amount ranging from 0.5 to 1.5 wt % relative to the crude collagen solution;
adjusting a pH value of the crude collagen solution to 5.5 to 7; and
incubating the crude collagen solution at 50° C. to 90° C. for 1 to 10 hours; and
inactivating the protease enzyme or the protease enzyme complex.

18. The method of claim 15, further comprising decolorizing the collagen peptide composition using activated carbon.

19. The method of claim 15, wherein the fish scale is dried, demineralized and obtained from a marine fish.

20. The method of claim 19, wherein the marine fish comprises pollock, cod, salmon or tuna.

21. The method of claim 15, wherein the fish scale is dried, demineralized and obtained from a freshwater fish.

22. The method of claim 21, wherein the freshwater fish comprises tilapia, carp or pangasius.
